(19) United States
(12) Patent Application Publication
(10) Pub. No.: US 2010/0223084 A1
(43) Pub. Date: Sep. 2, 2010

(54) METHODS AND SYSTEMS FOR ROUTING FUEL TO PORTABLE POWER GENERATORS

(75) Inventor: William E. Williamson, Marietta, GA (US)

Correspondence Address: AT&T Legal Department - HFZ;ATTN. Patent Docketing, One AT&T Way, Room 2A-207, Bedminstor, NJ, 07921, US

(73) Assignee: AT&T Intellectual Property I, L.P., Reno, NV (US)

(21) Appl. No.: 12/395,271

(22) Filed: Feb. 27, 2009

(51) Int. Cl. G06Q 10/00

(52) U.S. Cl. 705/8

(57) ABSTRACT

Methods and systems for routing fuel to portable power generators are described. In one embodiment, a plurality of generator burn rates may be calculated for a geographic area. A particular generator burn rate of the plurality of generator burn rates may be associated with a particular portable generator site in the geographic area. The particular burn rate may be based on an amount of fuel consumed by a particular portable electronic generator in a particular portable generator site during a time period. A fuel delivery route may be electronically generated for a plurality of portable generator sites in the geographic area based on the calculating of the plurality of generator burn rates. Additional methods and systems are disclosed.

### FIELD

This application relates to methods and systems for fuel routing, and more specifically to methods and systems for routing fuel to portable power generators.

### BACKGROUND

A company that relies on power to provide it services may deploy portable power generators to certain locations when power losses occur. By deploying the portable power generators, the company can continue to provide its services until commercial or ordinary power is restored. When the power loss is widespread (e.g., based on a catastrophic event), the company may have difficulty in maintaining, tracking and providing fuel (e.g., diesel, gasoline) to the portable power generators until commercial power is restored.

### BRIEF DESCRIPTION OF THE DRAWINGS

FIG. 1 is a block diagram of a system for managing deployment of portable power generators, according to an example embodiment;

FIG. 2 is a block diagram of a generator management server that may be deployed in the system of FIG. 1, according to an example embodiment;

FIG. 3 is a block diagram of a client machine that may be deployed in the system of FIG. 1, according to an example embodiment;

FIG. 4 is a block diagram of a fuel routing subsystem that may be deployed within generator management server of FIG. 2, the client machine of FIG. 3, or both, according to an example embodiment;

FIG. 5 is a block diagram of a flowchart illustrating a method for routing fuel to portable power generators, according to an example embodiment; and

FIG. 6 is a block diagram of a machine in the example form of a computer system within which a set of instructions for causing the machine to perform any one or more of the methodologies discussed herein may be executed.

### DETAILED DESCRIPTION

Example methods and systems for routing fuel to portable power generators are described. In the following description, for purposes of explanation, numerous specific details are set forth in order to provide a thorough understanding of example embodiments. It will be evident, however, to one of ordinary skill in the art that embodiments of the inventive subject matter may be practiced without these specific details.

Portable power generators may be deployed at a variety of sites in a geographic area on behalf of a company when the loss of commercial power prevents the company from continuing to provide at least some of its services. The portable power generators are generally capable of powering telecommunication or other equipment for twenty-four hours or more. In general, the portable power generators are 3,000 watts, 4500 watts, 5500 watts and weigh 150 pounds or more, however they may have higher and lower wattages and/or different weights. The portable power generators are generally carried on flat bed trucks for deployment. Once deployed, the portable power generators will power electronic equipment of the company by consuming fuel.

The company routes fuel to the various portable power generators at various sites in the geographic area primarily based on the burn rate of the fuel used by the portable power generators. The burn rate of the fuel is calculated for each portable power generator based on an amount of fuel consumed by the portable electronic generator in a time period between refueling. By including the burn rate of the portable power generators in the geographic area in the determination of how to route the fuel in the geographic area, there is a decreased likelihood that one or more of the portable power generators in the geographic area will run out of fuel on a particular day before being refueled.

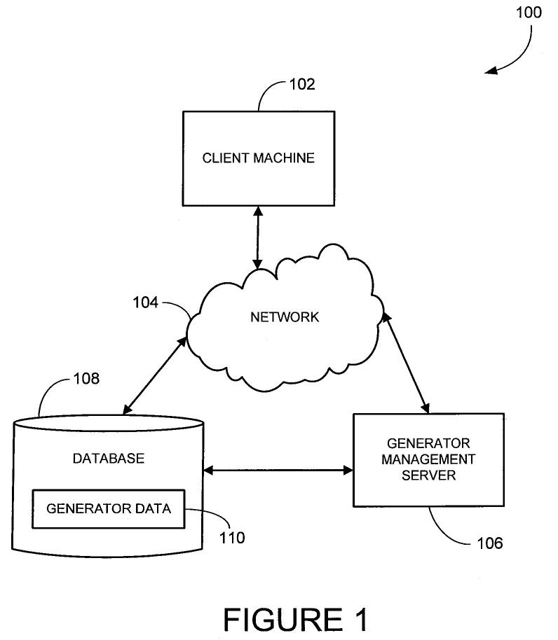

FIG. 1 illustrates an example system 100 in which a user operates a client machine 102 to route fuel to portable power generators. The client machine 102 may directly generate the fuel route, or it may receive the generated fuel route from a generator management server 106 that is in communication with the client machine 102 over a network 104. A technician or other person responsible for providing commercial power, backup power, or both may operate the client machine 102. In one specific embodiment, the operator of the client machine 102 may be part of an emergency restoration team that is restoring carrier services to parts of the geographic area. Carriers services may include telephone services, Internet services, television services, data services, and other similar services.

Examples of the client machine 102 deployed in the system 100 include a gaming unit, a receiver card, a set-top box (STB), a mobile phone, a personal digital assistant (PDA), a display device, a generic computing system, or the like. Other devices may also be used.

The network 104 over which the client machine 102 is in communication with the generator management server 106 may include a Global System for Mobile Communications (GSM) network, an Internet Protocol (IP) network, a Wireless Application Protocol (WAP) network, a WiFi network, or an IEEE 802.11 standards network, as well as various combinations thereof. Other conventional and/or later developed wired and wireless networks may also be used.

The generator management server 106 is a computing device operated by an entity that is managing the deployment of the portable power generators in the geographic area. The entity may be a telecommunications carrier or associated with the telecommunications carrier to enable the telecommunications carrier to continue to provide telecommunications services in the geographic area.

In some embodiments, the generator management server 106 tracks the operation of telecommunication equipment in various geographic areas to determine whether the equipment is still receiving commercial power (e.g., from a power company). The telecommunication equipment may include, by way of example, multiplexers, carrier equipment, Asymmetric Digital Subscriber Line (ADSL) equipment, or the like. When commercial power is not being provided to certain telecommunication equipment, the generator management server 106 may receive an alarm that indicates a lack of power to the telecommunication equipment. A portable power generator may then be manually or automatically dispatched to the affected areas to restore power to the telecommunication equipment.

In one embodiment, the generator management server 106 may receive the alarm from a network reliability center associated with the telecommunication equipment. The network reliability center may be operated by the same entity that operates the generator management server 106, a related entity, or a different entity. The alarm may be transmitted as part of an alarm list that indicates whether a site has a commercial power alarm, indicating that the telecommunication equipment at the site does not have commercial power.

The generator management server 106 may determine when commercial power has been restored to the affected areas. When a determination is made that commercial power has been restored, the portable power generators are returned back to their original pool or dispatched to other affected areas. In addition, the sites where the portable power generators are located may then be removed from an equipment dispatch list so that further attempts to fuel the portable power generator at the site are not made. The status and location of the portable power generators may be stored as generator data 110 in a database 108.

In some embodiments, the sites in the geographic area that are receiving or have received power from portable power generators are identified with site numbers. In a specific embodiment, these sites are identified with different, unique site numbers. The portable power generators may be identified with control numbers. The generator management server 106 may, in these embodiments, associate the site numbers with the control numbers to track the locations of the portable power generators. This association may then be used to identify sites on the fuel delivery list.

The generator management server 106 may operate as a central repository for information regarding deployment of the portable electronic generators. The information may be transmitted to the client machine 102 and other client machines periodically or on request. The client machine 102 and other client machines may transmit updates for the central repository to the generator management server 106.

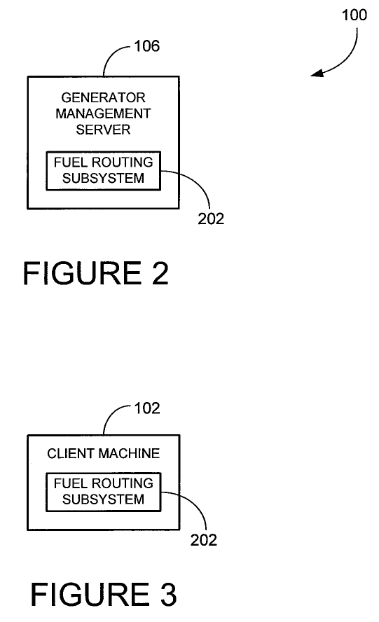

FIG. 2 illustrates an example generator management server 106 that may be deployed in the system 100, or otherwise deployed in another system. The generator management server 106 is shown to include a fuel routing subsystem 202 to electronically generate the fuel delivery route for the geographic area based on generator burn rates of the portable electronic generators in the geographic area. When the fuel delivery route has been generated on the generator management server 106, it is typically transmitted over the network 104 to the client machine 102 of to a user who has requested the fuel delivery route, where it may be printed out in hard copy or otherwise provided or communicated to a person responsible for providing fuel to the portable power generators in the geographic area, or both.

FIG. 3 illustrates an example client machine 102 that may be deployed in the system 100, or otherwise deployed in another system. The client machine 102 is shown to include the fuel routing subsystem 202 to electronically generate the fuel delivery route for the geographic area based on generator burn rates of the portable electronic generators in the geographic area. When the fuel delivery route is generated on the client machine 102, the client machine 102 typically communicates with the generator management server to receive updated information regarding the portable power generators in the geographic area so that the fuel delivery route is current.

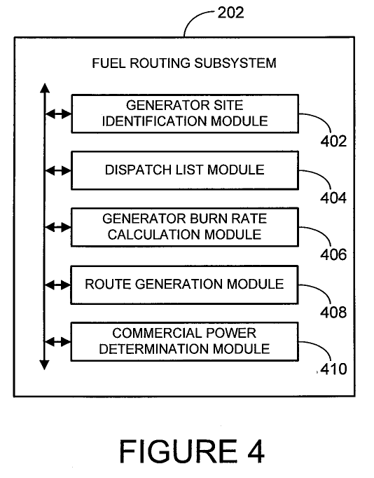

FIG. 4 illustrates an example fuel routing subsystem 202 that may be deployed in the client machine 102, the generator management server 106, or otherwise deployed in another system. One or more modules are included in the fuel routing subsystem 202 to enable routing of fuel to portable electronic generators. The modules of the fuel routing subsystem 202 that may be included are a generator site identification module 402, a dispatch list module 404, a generator burn rate calculation module 406, a route generation module 408, and a commercial power determination module 410. Other modules may also be included. The modules of the fuel routing subsystem 202 may be distributed. For example, some of the modules may be deployed in the client machine 102, while others may be deployed in the generator management server 106.

In some embodiments, portable generator sites are identified in the geographic area by the generator site identification module 402. In other embodiments, a dispatch list including identification of portable generator sites in the geographic area is accessed by the dispatch list module 404. The portable generator sites each include a portable electronic generator that has been previously deployed to provide power while commercial power is unavailable.

Generator burn rates are calculated by the generator burn rate calculation module 406 for the geographic area. A generator burn rate is based on an amount of fuel consumed by a portable electronic generator in a portable generator site during a time period. In one embodiment, the generator burn rates are calculated for at least some of the portable generator sites that have been identified. In another embodiment, the generator burn rates are calculated for at least some of the portable generator sites that have been included on the dispatch list.

The time period generally reflects the time it took for between refueling of a portable power generator. The time period may be approximately twenty-four hours, or a greater or lesser number of hours.

In some embodiments, the burn rate of the portable power generator is based on the portable electronic generator itself (e.g., the type, the model, etc.), the power draw from the portable electronic generator, and the amount of fuel consumed by the portable electronic generator during the time period.

In one embodiment, the power draw is based on telecommunication server equipment coupled to the portable electronic generators. The geographic area may then be a carrier service area wherein telecommunication and other carrier services are provided.

As part of the generator burn rate calculation, the generator burn rate calculation module 406 may receive the amount of fuel and a time of fueling for the portable electronic generator and determine the time period as a time duration or the elapsed time between the time of fueling and a previous time of fueling for the portable electronic generator.

The fuel delivery route for the portable generator sites in the geographic area is electronically generated by the route generation module 408 based on the calculation of the generator burn rates or the calculation of the generator burn rates and locations of the portable generator sites. In some embodiments, at least some of the portable generator sites that have a high burn rate are scheduled at or near the beginning of the fuel delivery route. The portable generator sites of the fuel delivery route may be grouped in a priority order, or they may be otherwise ordered.

In some embodiments, a determination of whether commercial power has been restored to some of the portable generator site is made by the commercial power determination module 410, and the portable generator sites are then removed from the dispatch list by the dispatch list module 404 when the determination is made that power has been restored.

In one embodiment, the determination is made by receiving an alarm list from a server (e.g., operated by a network reliability center) and comparing the alarm list with a previous alarm list to determine whether commercial power has been restored to some of the portable generator sites. The alarm list includes sites in the geographic area without commercial power.

A new fuel delivery route may be electronically generated on a daily basis. For example, the generator burn rates may be recalculated and the new fuel delivery route may be electronically generated for the portable generator sites prior to a daily fuel delivery. The recalculated burn rates may be based on the amount of fuel used between refueling and the amount of time between refueling.

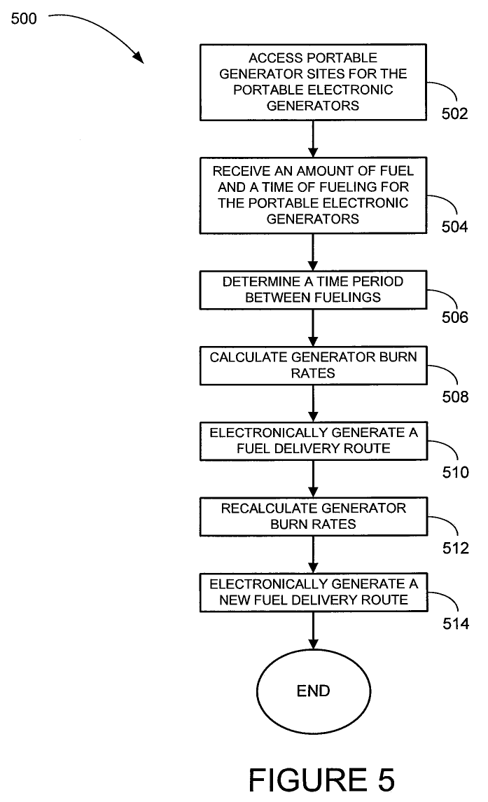

FIG. 5 illustrates a method 500 for routing fuel to portable power generators, according to an example embodiment. The method 500 may be performed by the client machine 102 and/or the generator management server 106 of the system 100 (see FIG. 1), or it may be otherwise performed.

The portable generator sites of the portable electronic generators may be accessed at block 502. In some embodiments, portable generator sites are identified in the geographic area. Each portable generator site may include an associated portable electronic generator. In other embodiments, a dispatch list including identification of portable generator sites in the geographic area is accessed.

In some embodiments, the amount of fuel and the time of fueling for the portable electronic generators are received at block 504. The time period, or duration between the time of fueling and a previous time of fueling for the portable electronic generators, is then determined at block 506. The

Generator burn rates are calculated for the geographic area at block 508. In some embodiments, the burn rate is based on the amount of fuel consumed by the portable electronic generator in the portable generator site during the time period. In other embodiments, the burn rate is based on the particular portable electronic generator, the power draw from the particular portable electronic generator, and the amount of fuel consumed by the particular portable electronic generator during a time period.

The fuel delivery route is electronically generated for portable generator sites in the geographic area at block 510 based on the calculation of the generator burn rates, or based upon the generator burn rates and the locations of the portable generator sites.

In some embodiments, at least some of the portable generator sites that have a high burn rate are scheduled at or near the beginning of the fuel delivery route. In some embodiments, the portable generator sites of the fuel delivery route are organized in priority order.

In some embodiments, a determination of whether commercial power has been restored to the portable generator site is performed and, based on the results, certain portable generator sites are removed from the dispatch list.

Generator burn rates may be recalculated daily or at different frequencies. For example, the generator burn rates for the geographic area may be recalculated at block 512, and the new fuel delivery route may be generated for the geographic area at block 514. The new fuel route may include the same portable generator sites or different portable generator sites.

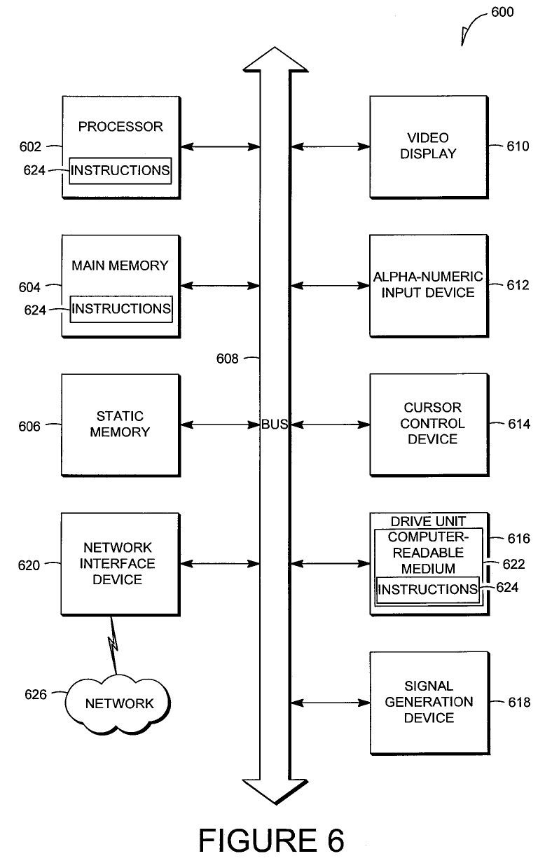

FIG. 6 shows a block diagram of a machine in the example form of a computer system 600 within which a set of instructions may be executed, causing the machine to perform any one or more of the methods, processes, operations, or methodologies discussed herein. The generator management server 106 of FIG. 1 may operate on one or more computer systems 600. The client machine 102 of FIG. 1 may include the functionality of the one or more computer systems 600.

In an example embodiment, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, a kiosk, a point of sale (POS) device, a cash register, an Automated Teller Machine (ATM), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 may include a processor 602 (e.g., a central processing unit (CPU) a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also may include an alphanumeric input device 612 (e.g., a keyboard), a cursor control device 614 (e.g., a mouse), a drive unit 616, a signal generation device 618 (e.g., a speaker) and a network interface device 620.

The drive unit 616 may include a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the methodologies of the inventive subject matter. The term “machine-readable medium” shall accordingly be taken to include, but not be limited to, solid-state memories, and optical media, and magnetic media.

Certain systems, apparatus, applications or processes are described herein as including a number of modules. A module may be a unit of distinct functionality that may be presented in software, hardware, or combinations thereof. When the functionality of a module is performed in any part through software, the module includes a machine-readable medium. The modules may be regarded as being communicatively coupled.

The inventive subject matter may be represented in a variety of different embodiments of which there are many possible permutations.

In an example embodiment, a plurality of generator burn rates may be calculated for a geographic area. A particular generator burn rate of the plurality of generator burn rates may be associated with a particular portable generator site in the geographic area. The particular burn rate may be based on an amount of fuel consumed by a particular portable electronic generator in a particular portable generator site during a time period. A fuel delivery route may be electronically generated for a plurality of portable generator sites in the geographic area based on the calculating of the plurality of generator burn rates.

Thus, methods and systems for routing fuel to portable power generators have been described. Although embodiments of the inventive subject matter have been described with reference to specific example embodiments, it will be evident that various modifications and changes may be made to these embodiments without departing from the broader spirit and scope of the embodiments of the inventive subject matter. Accordingly, the specification and drawings are to be regarded in an illustrative rather than a restrictive sense.

It should be noted that the methods described herein do not have to be executed in the order described, or in any particular order. Moreover, various activities described with respect to the methods identified herein can be executed in serial or parallel fashion.

It will be understood that although “End” blocks are shown in the flowcharts, the methods may be performed continuously.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A method comprising:
using one or more processors to perform at least some portion of the following
calculating a plurality of generator burn rates for a geographic area, a particular generator burn rate of the plurality of generator burn rates associated with a particular portable generator site in the geographic area, the particular generator burn rate based on an amount of fuel consumed by a particular portable electronic generator in the particular portable generator site during a time period; and
electronically generating a fuel delivery route for a plurality of portable generator sites in the geographic area based on the calculating of the plurality of generator burn rates, the plurality of generator burn rates including the particular portable generator site.

2. The method of claim 1, comprising:
identifying the plurality of portable generator sites in the geographic area, the particular portable generator site including the particular portable electronic generator; and
wherein the plurality of generator burn rates are calculated for the plurality of portable generator sites that have been identified.

3. The method of claim 1, comprising:
accessing a dispatch list including identification of the plurality of portable generator sites in the geographic area, the particular portable generator site of the plurality of portable generator sites including the particular portable electronic generator; and
wherein the plurality of generator burn rates are calculated for the plurality of portable generator sites that have been included on the dispatch list.

4. The method of claim 3, comprising:
determining whether commercial power has been restored to the particular portable generator site; and
removing the particular portable generator site from the dispatch list when a determination that commercial power has been restored to the particular portable generator site is made.

5. The method of claim 4, wherein the determining comprises:
receiving an alarm list from a server, the alarm list including a plurality of locations in the geographic area without commercial power; and
comparing the alarm list to a previous alarm list to determine whether the commercial power has been restored to the particular portable generator site.

6. The method of claim 1, wherein the particular burn rate is based on the particular portable electronic generator, a power draw from the particular portable electronic generator, and the amount of fuel consumed by the particular portable electronic generator during the time period.

7. The method of claim 6, wherein the amount of fuel consumed by the particular portable electronic generator during the time period is based on the particular portable electronic generator and the power draw on the particular portable electronic generator.

8. The method of claim 6, wherein the power draw is based on telecommunication server equipment coupled to the particular portable electronic generator.

9. The method of claim 8, wherein the geographic area is a carrier service area, and the telecommunication server equipment and other telecommunication server equipment provide carrier services in the carrier service area.

10. The method of claim 1, comprising:
receiving the amount of fuel and a time of fueling for the particular portable electronic generator;
determining the time period as a time duration or elapsed time between the time of fueling and a previous time of fueling for the particular portable electronic generator.

11. The method of claim 1, wherein the electronically generating of the fuel delivery route comprises:
electronically generating the fuel delivery route for the plurality of portable generator sites in the geographic area based on the plurality of generator burn rates and the plurality of portable generator sites.

12. The method of claim 1, further comprising:
recalculating the plurality of generator burn rates for the geographic area for a different day then the calculating of the plurality of generator burn rates; and
electronically generating a new fuel delivery route for the plurality of portable generator sites in the geographic area for the different day based on the recalculating of the plurality of generator burn rates.

13. A machine-readable medium comprising instructions, which when executed by one or more processors, cause the one or more processors to perform the following operations:
calculate a plurality of generator burn rates for a geographic area, a particular generator burn rate of the plurality of generator burn rates associated with a particular portable generator site in the geographic area, the particular burn rate based on an amount of fuel consumed by a particular portable electronic generator in the particular portable generator site during a time period; and
electronically generate a fuel delivery route for a plurality of portable generator sites in the geographic area based on the calculating of the plurality of generator burn rates.

14. The machine-readable medium of claim 13 further comprising instructions, which when implemented by one or more processors perform the following operations:
access a dispatch list including identification of the plurality of portable generator sites in the geographic area, the particular portable generator site of the plurality of portable generator sites including the particular portable electronic generator; and
wherein the plurality of generator burn rates are calculated for the plurality of portable generator sites that have been included on the dispatch list.

15. The machine-readable medium of claim 13 further comprising instructions, which when implemented by one or more processors perform the following operations:
receive the amount of fuel and a time of fueling for the particular portable electronic generator;
determine the time period as a time duration or elapsed time between the time of fueling and a previous time of fueling for the particular portable electronic generator.

16. A system comprising:
a generator burn rate calculation module to calculate a plurality of generator burn rates for a geographic area, a particular generator burn rate of the plurality of generator burn rates associated with a particular portable generator site in the geographic area, the particular burn rate based on an amount of fuel consumed by a particular portable electronic generator in the particular portable generator site during a time period; and
a route generation module to electronically generate a fuel delivery route for a plurality of portable generator sites in the geographic area based on the calculation of the plurality of generator burn rates by the generator burn rate calculation module.

17. The system of claim 16, comprising:
a dispatch list module to access a dispatch list including identification of the plurality of portable generator sites in the geographic area, the particular portable generator site of the plurality of portable generator sites including the particular portable electronic generator; and
wherein the plurality of generator burn rates are calculated for the plurality of portable generator sites that have been included on the dispatch list.

18. The system of claim 16, comprising:
a commercial power determination module to determine whether commercial power has been restored to the particular portable generator site; and
wherein the dispatch list module is further configured to remove the particular portable generator site from the dispatch list based when power has been restored.

19. The system of claim 16, wherein at least some of the plurality of portable generator sites that have a high burn rate are scheduled at or near a beginning of the fuel delivery route.

20. The system of claim 16, wherein the plurality of portable generator sites of the fuel delivery route are in priority order.

21. The system of claim 16, wherein the particular portable generator weighs at least one hundred and fifty pounds.
